(19) United States
(12) Patent Application Publication
(10) Pub. No.: US 2010/0082745 A1
(43) Pub. Date: Apr. 1, 2010

(54) SYSTEM FOR PROVIDING FEEDS FOR ENTITIES NOT ASSOCIATED WITH FEED SERVICES

(75) Inventors: Marc Davis, San Francisco, CA (US); Jeonghee Yi, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/239,972

(22) Filed: Sep. 29, 2008

(51) Int. Cl. G06F 15/16

(52) U.S. Cl. 709/204; 709/217

(57) ABSTRACT

A system is described for providing feeds for entities not associated with feed services. The system may include a processor, a memory and an interface. The memory may store an identifier of an entity, an update condition and a feed. The entity may include content, and the update condition may describe an update to the content. The interface may communicate with a device of the user. The processor may receive the identifier of the entity and the update condition of the entity via the interface. The processor may generate a feed for the entity and the processor may add the content to the feed when the content is updated in accordance with the update condition. The processor may then provide the feed to the device of the user via the interface.

### TECHNICAL FIELD

The present description relates generally to a system and method, generally referred to as a system, for providing feeds for entities not associated with feed services, and more particularly, but not exclusively, to automatically generating feeds for entities not associated with feed services.

### BACKGROUND

Feed services, such as web feeds, may provide users with frequently updated content. A content provider may publish a feed link on their site which end users may register with an aggregator program (also called a feed reader or a news reader) running on their own machine. When instructed, the aggregator asks all the servers in its feed list if they have new content; if so, the aggregator either makes a note of the new content, or downloads it. Aggregators may be scheduled to check for new content periodically. However, if the content publisher does not publish a feed link, the user may be unable to receive new content through the aggregator.

### SUMMARY

A system is disclosed for providing feeds for entities not associated with feed services. The system may include a processor, a memory and an interface. The memory may be operatively connected to the processor and the interface and may store an identifier of an entity, an update condition, and a feed. The entity may include content, and the update condition may describe an update to the content. The interface may communicate with a device of the user. The processor may receive the identifier of the entity via the interface. The processor may receive the update condition via the interface. The processor may generate a feed for the entity. The processor may add the content of the entity to the feed when the content of the entity is updated in accordance with the update condition, and the processor may provide the feed to the device of the user via the interface.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for providing feeds for entities not associated with feed services.

FIG. 2 is block diagram of a simplified view of a network environment implementing the system of FIG. 1 or other systems for providing feeds for entities not associated with feed services.

FIG. 3 is a block diagram of an information gathering system implementation in the system of FIG. 1 or other systems for providing feeds for entities not associated with feed services.

FIG. 4 is a block diagram of a data management system implementation in the system of FIG. 1 or other systems for providing feeds for entities not associated with feed services.

FIG. 5 is a block diagram of a feed generation system implementation in the system of FIG. 1 or other systems for providing feeds for entities not associated with feed services.

FIG. 6 is a flowchart illustrating operations the system of FIG. 1, or other systems for providing feeds for entities not associated with feed services.

FIG. 7 is a flowchart illustrating operations of generating feeds for entities not associated with feed services in the system of FIG. 1, or other systems for providing feeds for entities not associated with feed services.

FIG. 8 is a flowchart illustrating operations of providing a feed for an entity irrespective of whether the entity is associated with a feed service in the system of FIG. 1, or other systems for providing feeds for entities not associated with feed services.

FIG. 9 is an illustration a general computer system that may be used in a system for providing feeds for entities not associated with feed services.

### DETAILED DESCRIPTION

A system and method, generally referred to as a system, relate to providing feeds for entities not associated with feed services, and more particularly, but not exclusively, to automatically generating feeds for entities not associated with feed services. The principles described herein may be embodied in many different forms.

The system may allow a user to receive feed updates from an entity, irrespective of whether the entity provides a feed. If the entity does not provide a feed, the system may generate a feed for the entity, and may provide the feed to the user. The system may monitor the entity and provide any changes to the entity to the user via the feed. Alternatively or in addition the system may allow the user to specify an update condition for the entity. The update condition identifies which updates to the entity, or to the feed provided by the entity, the system should provide to the user. In other words, the system may not provide every update of the entity to the user, but only the updates which satisfy the condition specified by the user.

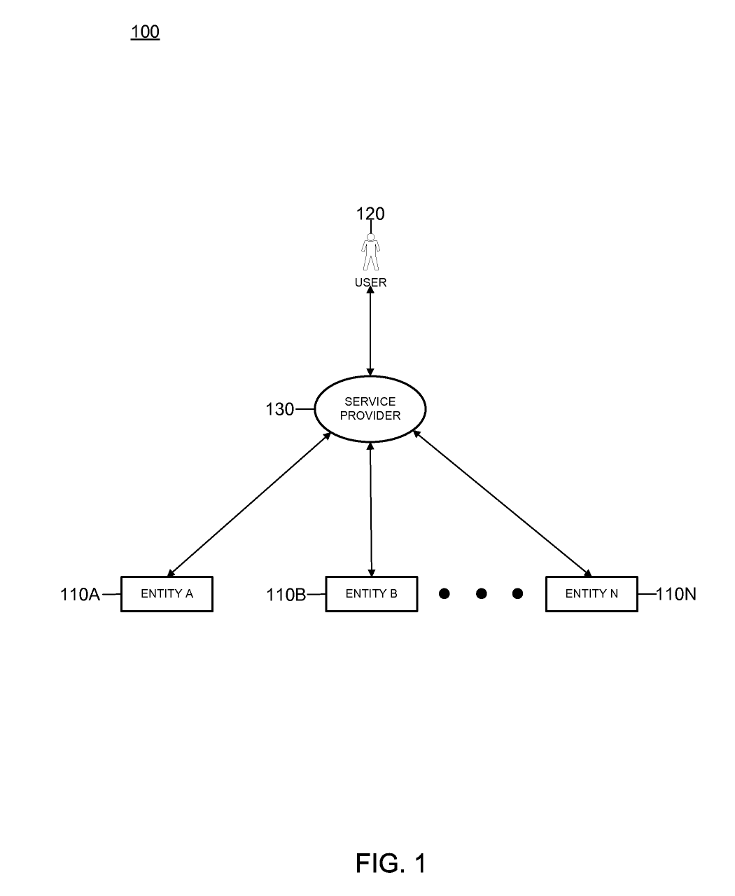

FIG. 1 provides a general overview of a system 100 for providing feeds for entities not associated with feed services. Not all of the depicted components may be required, however, and some implementations may include additional components. Variations in the arrangement and type of the components may be made without departing from the spirit or scope of the claims as set forth herein. Additional, different or fewer components may be provided.

The system 100 includes a user 120, a service provider 130 and one or more entities 110A-N. The service provider 130 may provide a centralized portal where the user 120 can register for and view feeds, such as really simple syndication (“RSS”) feeds or atom feeds, for the entities 110A-N. The user 120 may use an interface, such as a web browser, to access the portal to register for and view the feeds. Alternatively or in addition the user 120 may only use the portal to register for the feeds and may use a feed reader, or aggregator, for retrieving the feeds from the service provider 130 and viewing the feeds. The user 120 may register for the feeds irrespective of whether the entities 110A-N provide a standard feed. An entity A 110A may be an object, an event, a service, and/or any attributes of an object/event or service which are changing over time, such as a sports game, a game score, a news event, a stock quote, a web service content, a product information, or generally any content hosted at a network location.

Feeds, or web feeds, may be a data format used by the entities 110A-N and the service provider 130 to provide the user 120 with frequently updated content. The entities 110A-N, also referred to as content distributors, may syndicate a feed by publishing a feed link on their web site. The user 120 may subscribe to a syndicated feed to receive the frequently updated content when it becomes available. The feeds may be used to deliver any type of content, such as hyper text markup language (“HTML”) content, multimedia content, or generally any content which can be delivered over a network.

In operation, the user 120 may register for a feed for one of the entities 110A-N, such as the entity A 110A, via the service provider 130, irrespective of whether the entity A 110A provides a standard feed. When the user 120 registers for feed services for the entity A 110A, the service provider 130 checks to determine whether the entity A 110A provides a standard feed. If the entity A 110A provides a standard feed, the service provider 130 accesses the feed and relays the feed to the user 120. The service provider 130 may access the feed through the feed protocol implemented by the entity A 110A, such as RSS or atom, and may download any new content from the feed. The service provider 130 may then relay the content to the user 120 though a feed provided by the service provider 130. If the entity A 110A does not provide a standard feed, the service provider 130 may automatically create a feed for the entity A 110A, and provide the feed to the user 120. The service provider 130 may monitor the entity A 110A for updated content, and may provide the updated content to the user 120 via the generated feed.

Alternatively or in addition, instead of providing all updates of the entity A 110A to the user 120, the service provider 130 may allow the user 120 to identify which updates should be provided. The service provider 130 may provide an interface to the user 120 to allow the user to identify an update condition for the entity A 110A. The update condition may describe an update to the entity A 110A, or a feed provided by the entity A 110A, such as updates to a specified area of the web site. The service provider 130 may then only provide updates of the entity A 110A to the user 120 when the updates satisfy the update condition. For example, in the case where the entity A 110A is a web site displaying the score of a sporting event, the user 120 may identify the update condition as a change in the score of the sporting event. In this case, the service provider 130 may only provide updated content to the user 120 via the feed if the score changes, not when other data displayed on the entity A 110A changes, such as other statistics related to the sporting event. Alternatively or in addition the user 120 may configure one or more variables related to the feed, such as the number of messages in the feed, the interval the feed is updated, or generally any variable capable of configuring the feed. Alternatively or in addition the user 120 may select to have updates to the entity A 110A sent, by the service provider 130, to an email account, a voicemail account, a messaging service account, such as a short messaging service (“SMS”) on a mobile device, or generally any other method of communicating the update to the user 120.

The service provider 130 may collect user behavior data from the user 120, such as which feeds the user 120 subscribes to, which updates in the feeds the user 120 demonstrates interest in, or generally any interactions the user 120 has with the service provider 130. The service provider 130 may use the user behavior data to provide advertisements to the user 120. Alternatively or in addition the service provider 130 may provide advertisements to the user 120 relevant to the content delivered by the feeds, the content of the entities 110A-N, the content contained in the update condition, the update condition, or generally any data exposed to the user 120. The service provider 130 may provide the advertisements to the user 120 appended to updated content in the feed. Alternatively or in addition the advertisements may be displayed to the user 120 as part of the portal used by the user 120 to register for and view the feeds. The advertisements may include text elements, graphical elements, audio elements, multimedia elements, or generally any elements capable of attracting the interest of the user 120.

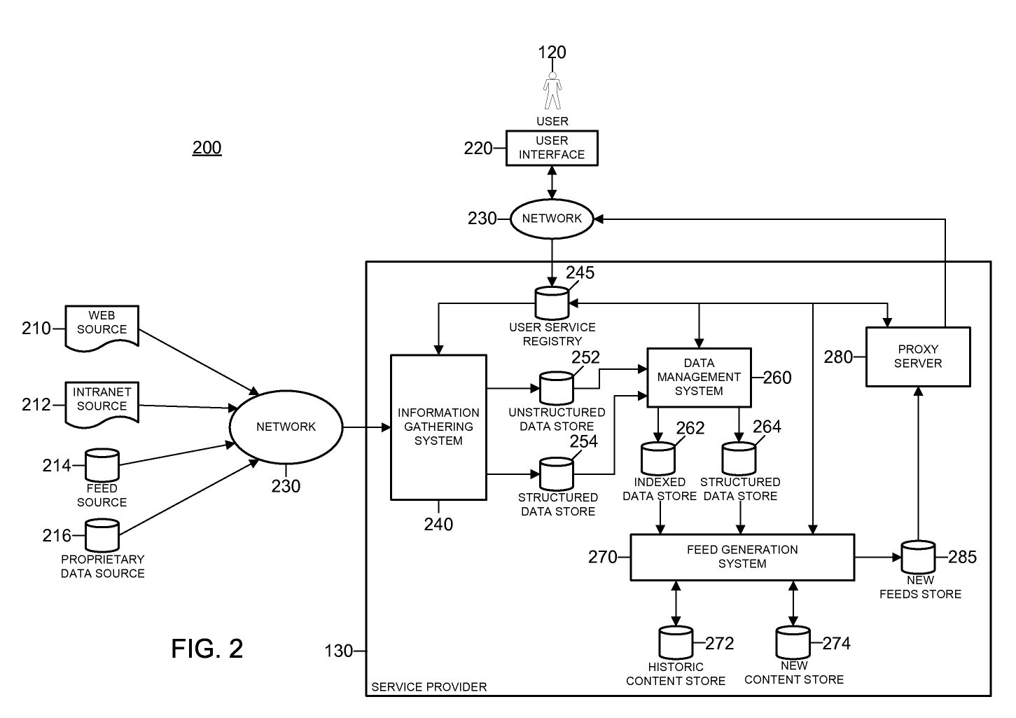

FIG. 2 provides a simplified view of a network environment implementing a system 200 for providing feeds for entities not associated with feed services. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The system 200 may include a web source 210, an intranet source 212, a feed source 214, a proprietary data source 216, a user 120, a user interface 220, networks 230, and a service provider 130. The service provider 130 may include an information gathering system 240, a user service registry 245, an unstructured data store 252, a structured data store 254, a data management system 260, an indexed data store 262, a structured data store 264, a feed generation system 270, a historic content store 272, a new content store 274, a new feeds store 285, and a proxy server 280.

The web source 210, intranet source 212, feed source 214 and proprietary data source 216 may represent one or more of the entities 110A-N. The web source 210 may be any web site hosting content, such as a sports web site, a news web site, or a financial web site. The intranet source 212 may be a web site hosted on a private intranet, such as a corporate web page. The feed source 214 may be a feed link provided by a web site. The proprietary data source 216 may be proprietary data hosted by a third party application not accessible though the web, such as an file transfer protocol (“FTP”) site. The web source 210, the intranet source 212 and the proprietary data source 216 may not provide feeds.

The user interface 220 may be a computing device, such as a computer, a mobile phone, personal digital assistant (“PDA”), pager, network-enabled television, digital video recorder, such as TIVO®, automobile and/or any appliance capable of data communications. The user interface 220 may be running a web application, a standalone application, or a mobile application, such as a mobile web browser. The user interface 220 may be connected to the network 230 in any configuration that supports data transfer. This may include a data connection to the network 230 that may be wired or wireless, such as a Global System for Mobile communications (“GSM”) connection, a General Packet Radio Service (“GPRS”) connection, a Wideband Code Division Multiple Access (“WCDMA”) connection, a wireless data connection, an internet connection, an infra-red connection, a Bluetooth connection, or any other connection capable of transmitting data. The data connection may be used to connect directly to the network 230, or to connect to the network 230 through a proxy server.

The networks 230 may be configured to couple one computing device to another computing device to enable communication of data between the devices. The networks 230 may generally be enabled to employ any form of machine-readable media for communicating information from one device to another. The networks 230 may include wide area networks (“WAN”), such as the internet, mobile networks, local area networks (“LAN”), campus area networks, metropolitan area networks, or any other networks that may allow for data communication. The networks 230 may include the Internet and may be divided into sub-networks. The sub-networks may allow access to all of the other components connected to the networks 230 in the system 200, or the sub-networks may restrict access between the components connected to the networks 230. The networks 230 may be regarded as a public or private network connection and may include, for example, a virtual private network or an encryption or other security mechanism employed over the public Internet, or the like.

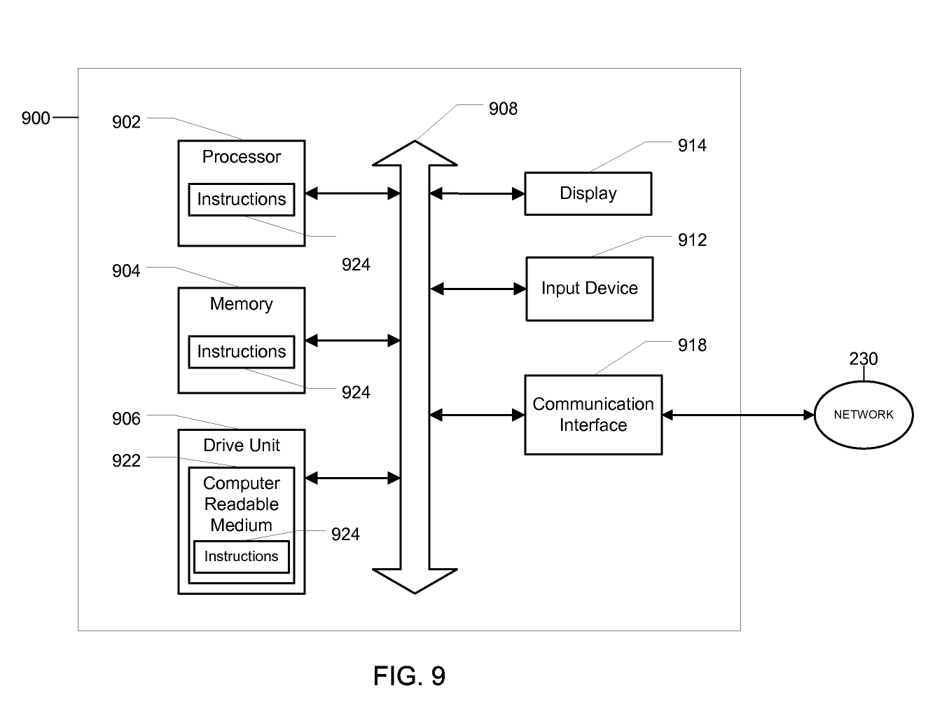

The information gathering system 240, the data management system 260, the feed generation system 270, and the proxy server 280 may be processes running on a server of the service provider 130, or may be separate systems including one or more of the computing devices described in FIG. 9 below. The user service registry 245, the unstructured data store 252, the structured data store 254, the indexed data store 262, the structured data store 264, the historic content store 272, the new content store 274, and the new feeds store 285 may be stored in memory on a server of the service provider 130 or may be separate database servers, such as MICROSOFT SQL SERVER, ORACLE, or IBM DB2 database servers.

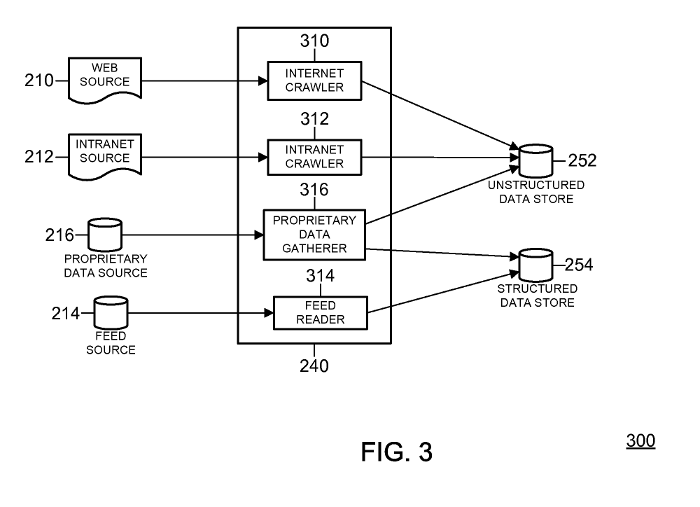

In operation, the user 120 may register for updates of one of the entities 110A-N, such as the web source 210, the intranet source 212, the feed source 214, or the proprietary data source 216, through the user interface 220. The user 120 may also identify the update condition that determines which updates to an entity A 110A should be provided to the user 120 through a feed. The service provider 130 may receive the request and add an identifier of the entity A 110A and the update condition to the user service registry 245. The information gathering system 240 may retrieve the entities 110A-N registered by the user 120 from the user service registry 245. The information gathering system 240 may retrieve data, such as content, from the registered entities through one or more of the web source 210, the intranet source 212, the feed source 214, or the proprietary data source 216. The information gathering system 240 may store retrieved structured data, such as data retrieved form a feed source 214, in the structured data store 254. The information gathering system 240 may store retrieved unstructured data, such as data retrieved from the web source 210, the intranet source 212, or the proprietary data source 216, in the unstructured data store 252. The information gathering system 240 may be described in more detail in FIG. 3 below.

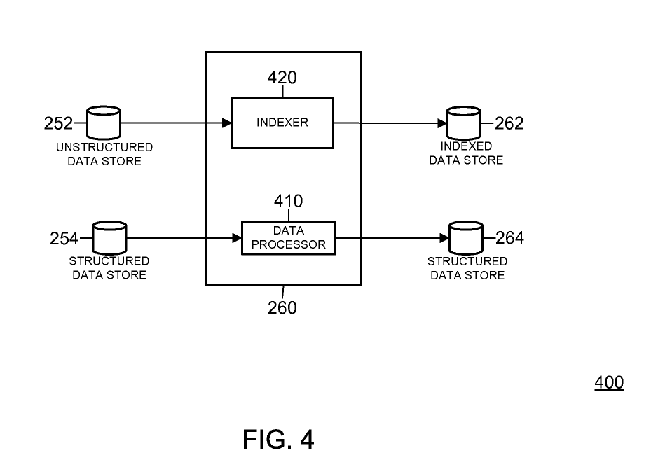

The data management system 260 may retrieve the unstructured data from the unstructured data store 252, may index the data in the unstructured data, and may store the indexed data in the indexed data store 262. The data management system 260 may retrieve the data from the structured data store 254, may organize and sort the structured data, and may store the organized structured data in the structured data store 264. The data management system 260 may be described in more detail in FIG. 4 below.

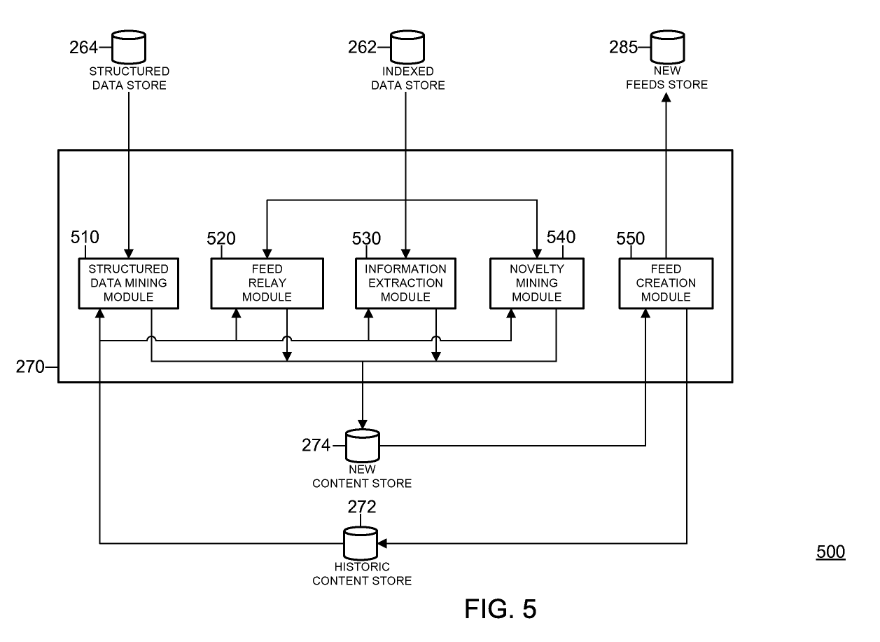

When an update to an entity A 110A is provided to the feed generation system 270, the feed generation system 270 may move any existing content for the entity A 110A stored in the new content store 274 to the historic content store 272. The feed generation system 270 may store the updated content in the new content store 274. The feed generation system 270 may then compare the content of the entity A 110A in the new content store 274 with the content of the entity A 110A in the historic content store 272. If the comparison indicates that the update condition for the entity A 110A has been met, the feed generation system 270 provides the update to the new feeds store 285. Alternatively or in addition if the entity A 110A provides updates through a feed, the feed generation system 270 provides updates to the feed to the new feeds store 285. The feed generation system 270 may be discussed in more detail in FIG. 5 below.

The proxy server 280 may retrieve feeds added to the new feeds store 285 and may provide the feeds to the user interface 220 via the network 230 at the request of the user interface 220. The user interface 220 may periodically request feed updates from the proxy server 280. The proxy server 280 may provide the feed data through a feed protocol specified by the user 120 and/or the user interface 220, such a really simple syndication feed protocol. Alternatively or in addition the proxy server 280 may deliver the updates to the user 120 via email, voicemail, an SMS message, or generally any method of communicating the feed data.

FIG. 3 illustrates a block diagram of an information gathering system implementation 300 in the system of FIG. 1 or other systems for providing feeds for entities not associated with feed services. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The implementation 300 may include a web source 210, an intranet source 212, a proprietary data source 216, a feed source 214, an information gathering system 240, an unstructured data store 252, and a structured data store 254. The information gathering system 240 may include an internet crawler 310, an intranet crawler 312, a proprietary data gatherer 316, and a feed reader 314. The information gathering system 240 may communicate with the web source 210, the intranet source 212, the proprietary data source 216 and the feed source 214 via the network 230.

In operation, the feed reader 314 may retrieve updates from the entities 110A-N identified by the user 120 which provide feeds. The feed reader 314 may be aware of the feed protocols implemented by each of the entities 110A-N, such as RSS or atom. The internet crawler 310 may retrieve updates via the internet from the entities 110A-N identified by the user 120 which are web sources 210 not providing feeds. The intranet crawler 312 may retrieve updates via an intranet, such as a corporate intranet, from the entities 110A-N identified by the user 120 which are intranet sources 212 not providing feeds. The intranet crawler 312 may be able to retrieve data from password protected sites that the user 120 has access to. The user 120 may provide the authentication information to the service provider 130 and the intranet crawler 312 may use the authentication information to retrieve updates from the intranet sources 212. The proprietary data gatherer 316 may retrieve updates from the entities 110A-N identified by the user 120 which are proprietary data sources 216 not providing feeds. The proprietary data gatherer 316 may receive and/or retrieve data from third party services, such as election results. The proprietary data gatherer 316 may have a wrapper for each of the proprietary data sources 216. The wrappers may allow the proprietary data gatherer 316 to transform data retrieved from each of the proprietary data sources 216 into a standard format.

FIG. 4 illustrates a data management system implementation 400 in the system of FIG. 1 or other systems for providing feeds for entities not associated with feed services. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The implementation 400 may include an unstructured data store 252, an indexed data store 262, a structured data store 254, a structured data store 264, and a data management system 260. The data management system 400 may include a data processor 410 and an indexer 420. In operation, the indexer 420 may parse each data item in the unstructured data store 252. The indexer 420 may index the parsed data and may store the indexed data in the indexed data store 262. The data processor 420 may process the data from the structured data store 254, such as by organizing the data or sorting the data. The data processor 420 may store the processed data in the structured data store 264.

FIG. 5 illustrates a feed generation system implementation 500 in the system of FIG. 1 or other systems for providing feeds for entities not associated with feed services. in the system of FIG. 1, or other systems for providing feeds for entities not associated with feed services. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The implementation 500 may include a structured data store 264, an indexed data store 262, a new feeds data store 285, a new content store 274, a historic content store 272, and a feed generation system 270. The feed generation system 270 may include a structured data mining module 510, a feed relay module 520, an information extraction module 530, a novelty mining module 540, and a feed creation module 550.

In operation, the feed relay module 520 may retrieve an updated feed of one of the entities 110A-N identified by the user 120 and may add the feed to the new content store 274. The feed relay module 520 may enter a record for each updated feed item into the new content store 274. The feed relay module 274 may implement various types of feed protocols, such as RSS and atom, in order to properly retrieve the feeds from the entities 110A-N. The structured data mining module 510 may identify an updated value of an entity A 110A and may make the update available in the new content store 274. The structured data mining module 510 may identify an update by comparing the previous value of the entity A 110A in the historic content store 272 with the current value of the entity A 110A. If the structured data mining module 510 identifies an update, and the update satisfies any update condition identified by the user 120, the structured data mining module 510 stores the update in the new content store 274.

The information extraction module 530 may periodically extract a field identified by the user 120 from a web page of an entity A 110A, or any other unstructured information. The information extraction module 530 may compare the retrieved value with the previous value in the historic content store 272. If the information extraction module 530 identifies an update, and the update satisfies any update condition identified by the user 120 for the entity A 110A, the information extraction module 530 may insert a new record for the current value in the new content store 274. The information extraction module 530 may receive web page data each time the web page is crawled by the internet crawler 310.

The novelty mining module 540 may find a page related to a subject specified by the user 120, of which novelty is high. The novelty mining module 540 may topically classify each new page that is crawled by the internet crawler 310. In this case the internet crawler 310 may retrieve pages from the entire internet, not just from the entities 110A-N registered for by the user 120. The novelty mining module 540 may determine whether the topic of a page is a topic that was identified by the user 120 via the interface 220. If the topic of a page is a topic identified by the user 120, the novelty mining module 540 may determine a novelty score of the page. The novelty score may be calculated by an algorithm that determines whether the information conveyed in the page is both new, and not already provided to the user 120. The algorithm may access the historic content store 272 to determine the information previously provided to the user 120. If the algorithm determines that the page is new, and contains information not previously provided to the user 120, the novelty score of the page may be high. If the novelty score surpasses a novelty score threshold, such as 80, a new record for the page may be inserted into the new content store 274.

For example, the novelty mining module 540 may consider a document to be new if the percentage of content in the document that the user 120 has not previously seen meets a threshold. In one example, the percentage of content previously unseen by the user 120 can be computed by a percentage of new hash values of shingles. A shingle may be a small window of consecutive words, characters, or bytes, depending on the implementation and the type of data. A document may be divided into multiple overlapping size n shingles. For example, shingle(i) may be a window of text from word location i to i+(n−1). For each shingle(i), the novelty mining module 540 may compute a hash value of the shingle, such as a message digest algorithm 5 (MD5) hash. Hash values of all the shingles of the documents of the same topic in the corpus that were previously shown to the user may be pre-computed and stored. A document may be considered new if the percentage of shingles of the document that do not exist in the corpus is higher than a given threshold.

The feed creation module 550 retrieves data from the new content store 274 for each of the entities 110A-N and transforms the data into a feed. The feed may be generated in accordance with the specifications identified by the user 120, such as the periodic time interval the feed is provided, the number of messages in the feed, or generally any configuration of the feed identified by the user 120. The feeds generated by the feed creation module 550 may then be stored in the new feeds store 285. The proxy server 280 may provide the feeds from the new feeds store 285 to the interface 220 of the user 120 via the network 230.

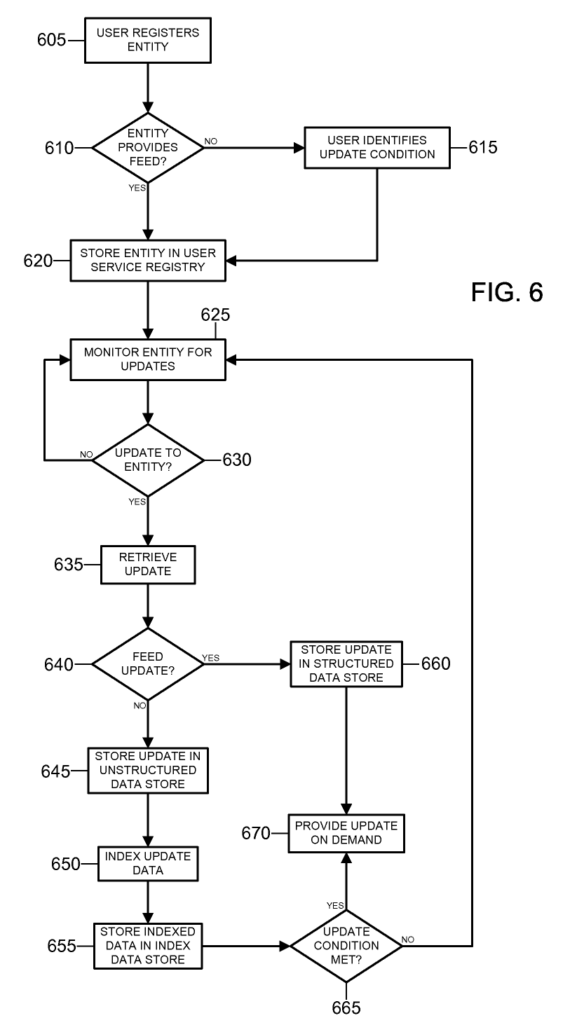

FIG. 6 is a flowchart illustrating operations the system of FIG. 1, or other systems for providing feeds for entities not associated with feed services. At block 605 the user 120 may register an entity A 110A. The entity A 110A may be a regularly updated source of information the user 120 wishes to be kept apprised of. At block 610 the system 100 determines whether the entity A 110A provides a feed. The feed may provide information that is regularly updated on the entity A 110A. If, at block 610, the system 100 determines that the entity A 110A does not provide a feed, the system 100 may move to block 615. At block 615, the user 120 may identify an update condition for the entity A 110A. The update condition may identify the updates to the entity A 110A that the user 120 wishes to be kept apprised of. For example, if the entity A 110A represents a scoreboard of a sporting event, the user 120 may only wish to be kept apprised of changes to the score of the sporting event, not changes to other statistics, or other changes to the entity A 110A. In this case, the user 120 may identify the value of the score as the update condition. When the value of the score changes, the system 100 may provide an update to the user 120 via a feed.

If at block 610, the system 100 determines that the entity A 110A does provide a feed, the system 100 may move to block 620. At block 620 the system 100 stores a descriptor of the entity A 110A, and any associated update condition in the user service registry 245. If the entity A 110A provides a feed, the service provider 130 may store a feed link of the entity A 110A in the user service registry 245. If the entity A 110A does not provide a feed, the service provider 130 may store the network address of the entity A 110A in the user service registry 245. Alternatively or in addition the system 100 may also allow the user 120 to identify an update condition for an entity A 110A that provides a feed.

At block 625 the system 100 may monitor the entity A 110A for updates. At block 630 the system 100 may determine whether the entity A 110A was updated. If at block 630, the system 100 determines that the entity A 110A was not updated, the system 100 returns to block 625 and continues to monitor the entity A 110A for updates. If, at block 630, the system 100 determines that the entity A 110A was updated, the system 100 moves to block 630. At block 630 the system 100 retrieves the updated data from the entity A 110A, via the feed link or the network address of the entity A 110A. At block 640 the system 100 determines whether the update was retrieved from a feed, or any other structured data source. If, at block 640, the system 100 determines that the update was retrieved from a feed, the system 100 moves to block 660. At block 660 the system 100 may store the update in the structured data store 264. At block 670 the system 100 may provide the update to the user 120 in the form of a feed, in accordance with any feed configurations identified by the user 120, via the interface 220. Alternatively or in addition the system 100 may provide the update to the user 120 via email, voicemail, a short messaging system, or generally via any method of providing data. Alternatively or in addition if the user 120 specifies an update condition for the structured data, the system 100 may move to block 665 to determine whether the update condition is met before moving to block 670.

If, at block 640, the system 100 determines that the update was not retrieved from a feed or other structured data source, the system 100 moves to block 645. At block 645 the system 100 stores the update in the unstructured data store 252. At block 650 the system 100 indexes the update in the unstructured data store 252 and stores the indexed update in the indexed data store 262. At block 665 the system 100 determines whether the update condition identified by the user 120 for the entity A 110A, if any, is met by the update. If, at block 665, the system 100 determines that the update condition, if any, is not met by the update, the system 100 returns to block 625 and continues to monitor the entity A 110A for additional updates. If, at block 665, the system 100 determines that the update condition is met, or is not specified for the entity A 110A, the system 100 moves to block 670. At block 670 the system 100 makes the update available to the user 120 via a feed, and provides the update to the user 120 on demand.

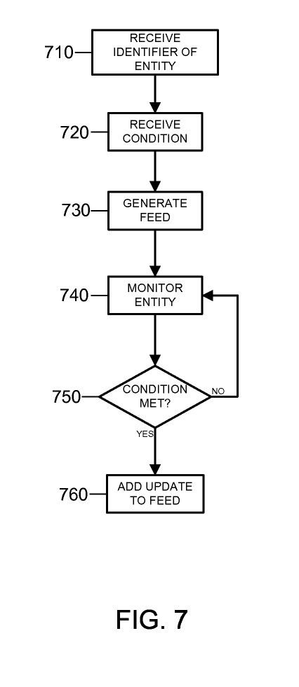

FIG. 7 is a flowchart illustrating operations of generating feeds for entities not associated with feed services in the system of FIG. 1, or other systems for providing feeds for entities not associated with feed services. At block 710 the system 100 receives an identifier of the entity A 110A. The identifier may describe a feed link or a network address of the entity A 110A. At block 720 the system 100 may receive an update condition for the entity A 110A. The update condition may identify an area, portion, or value of the page that should be monitored for updates. The update condition may be met if an update to the page includes an update to the part of the page identified in the update condition.

At block 730 the system 100 may generate a feed for the entity A 110A. The feed may provide the updates of the entity A 100A, which satisfy the update condition, to the interface 220 of the user 120. At block 740 the system 100 may monitor the entity A 110A for updates. At block 750 if the system 100 has detected an update to the entity A 110A, the system 100 determines whether the update satisfies the criteria identified in the update condition. If the update does not satisfy the update condition, the system 100 returns to block 740 and continues to monitor the entity A 110A for updates.

If, at block 750, the system 100 determines that an update meets the update condition, the system 100 moves to block 760. At block 760 the system 100 adds the update to the feed and continues to provide the feed, on demand, to the user 120. Alternatively or in addition the system 100 may provide the update to the user 120 via a push mechanism, such as an email, a voicemail, a messaging service, or generally via any method of pushing the update to the user 120.

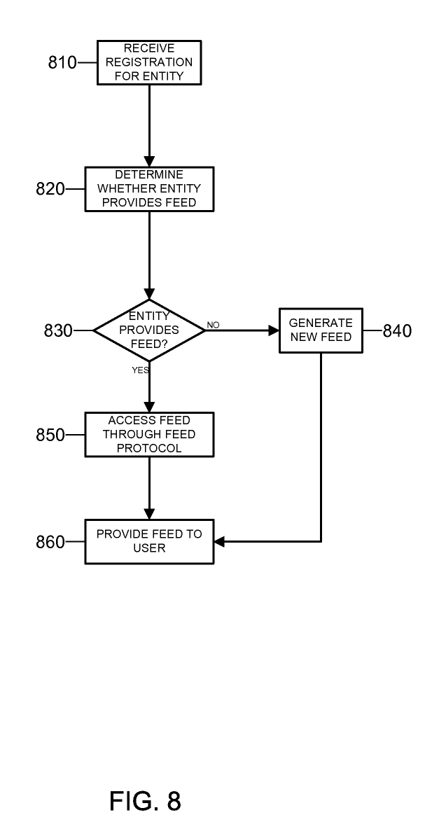

FIG. 8 is a flowchart illustrating operations of providing a feed for an entity irrespective of whether the entity is associated with a feed service in the system of FIG. 1, or other systems for providing feeds for entities not associated with feed services. At block 810 the system 100 may receive a registration for updates from an entity A 110A. At block 820 the system 100 may determine whether the entity A 110A provides a feed for communicating updates to the entity A 110A. The system 100 may implement multiple feed protocols, such as RSS, atom, etc., in order to communicate with any feed implemented by the entity A 110A. If, at block 820, the system 100 determines that the entity A 110A does not implement a feed, the system 100 may move to block 840. At block 840 the system 100 may generate a new feed for the entity A 110A. The new feed may provide updates to the user 120 when the entity A 110A is updated. Alternatively or in addition the user 120 may identify one or more update conditions, or criteria. In this case, the system 100 may not provide an update of the entity A 110A to the user 120 unless the update satisfies the update condition. Alternatively or in addition the user 120 may identify configuration variables of the feed, such as how often the feed makes updates available, the number of messages in the feed, or generally any variable for configuring the feed.

If at block 830, the system 100 determines that the entity A 110A provides a feed, the system 100 may move to block 850. At block 850 the system 100 may access the feed provided by the entity A 110A through the feed protocol implemented by the entity A 110A. The system 100 may implement multiple feed protocols, such as RSS, atom, etc., in order to communicate with any feed protocol implemented by the entities 110A-N. At block 860, the system 100 may provide a feed for the entity A 110A to the user 120, irrespective of whether the entity A 110A provides a feed itself. The feed may be either a new feed created by the system 100 and provided to the user 120, or a relayed feed retrieved from the entity A 110A and provided to the user 120.

FIG. 9 illustrates a general computer system 900, which may represent a service provider 130, or any of the other computing devices referenced herein. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The computer system 900 may include a set of instructions 924 that may be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 900 may also be implemented as or incorporated into various devices, such as a personal computer (“PC”), a tablet PC, a set-top box (“STB”), a personal digital assistant (“PDA”), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 924 (sequential or otherwise) that specify actions to be taken by that machine. In a particular embodiment, the computer system 900 may be implemented using electronic devices that provide voice, video or data communication. Further, while a single computer system 900 may be illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, such as, a central processing unit (“CPU”), a graphics processing unit (“GPU”), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 904 may include a cache or random access memory for the processor 902. Alternatively or in addition, the memory 904 may be separate from the processor 902, such as a cache memory of a processor, the system memory, or other memory. The memory 904 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 904 may be operable to store instructions 924 executable by the processor 902. The functions, acts or tasks illustrated in the figures or described herein may be performed by the programmed processor 902 executing the instructions 924 stored in the memory 904. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 900 may further include a display 914, such as a liquid crystal display (“LCD”), an organic light emitting diode (“OLED”), a flat panel display, a solid state display, a cathode ray tube (“CRT”), a projector, a printer or other now known or later developed display device for outputting determined information. The display 914 may act as an interface for the user to see the functioning of the processor 902, or specifically as an interface with the software stored in the memory 904 or in the drive unit 906.

Additionally, the computer system 900 may include an input device 912 configured to allow a user to interact with any of the components of system 900. The input device 912 may be a number pad, a keyboard, or a cursor control device, such as a mouse, or a joystick, touch screen display, remote control or any other device operative to interact with the system 900.

The computer system 900 may also include a disk or optical drive unit 906. The disk drive unit 906 may include a computer-readable medium 922 in which one or more sets of instructions 924, e.g. software, can be embedded. Further, the instructions 924 may perform one or more of the methods or logic as described herein. The instructions 924 may reside completely, or at least partially, within the memory 904 and/or within the processor 902 during execution by the computer system 900. The memory 904 and the processor 902 also may include computer-readable media as discussed above.

The present disclosure contemplates a computer-readable medium 922 that includes instructions 924 or receives and executes instructions 924 responsive to a propagated signal; so that a device connected to a network 230 may communicate voice, video, audio, images or any other data over the network 230. The instructions 924 may be implemented with hardware, software and/or firmware, or any combination thereof. Further, the instructions 924 may be transmitted or received over the network 230 via a communication interface 918. The communication interface 918 may be a part of the processor 902 or may be a separate component. The communication interface 918 may be created in software or may be a physical connection in hardware. The communication interface 918 may be configured to connect with a network 230, external media, the display 914, or any other components in system 900, or combinations thereof. The connection with the network 230 may be a physical connection, such as a wired Ethernet connection or may be established wirelessly as discussed below. Likewise, the additional connections with other components of the system 900 may be physical connections or may be established wirelessly.

The network 230 may include wired networks, wireless networks, or combinations thereof. The wireless network may be a cellular telephone network, an 802.11, 802.16, 802.20, or WiMax network. Further, the network 230 may be a public network, such as the Internet, a private network, such as an intranet, or combinations thereof, and may utilize a variety of networking protocols now available or later developed including, but not limited to TCP/IP based networking protocols.

The computer-readable medium 922 may be a single medium, or the computer-readable medium 922 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 922 may include a solid-state memory such as a memory card or other package that houses one or more non-volatile read-only memories. The computer-readable medium 922 also may be a random access memory or other volatile re-writable memory. Additionally, the computer-readable medium 922 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A computer implemented method of providing an update to an entity via a feed, comprising:
receiving an identification of an entity from a user;
receiving an update condition for the entity, the update condition describing an update to a content of the entity;
generating a feed for the entity;
adding the content of the entity to the feed when the content is updated in accordance with the update condition; and
providing the feed to the user.

2. The computer implemented method of claim 1 wherein the feed comprises a web feed.

3. The computer implemented method of claim 1 further comprising receiving a configuration of the feed service from the user.

4. The computer implemented method of claim 3 wherein the configuration comprises a time interval, the time interval indicating how often the content should be added to the feed.

5. The computer implemented method of claim 1 further comprising providing the content to the user through a messaging service when the content is updated in accordance with the update condition.

6. The computer implemented method of claim 5 wherein the messaging service comprises at least one of an email service, a text messaging service, a video messaging service, an audio messaging service, or a voicemail service.

7. The computer implemented method of claim 1 wherein the entity comprises at least one of a web page, an intranet page, a feed, or a proprietary data source.

8. The computer implemented method of claim 1 wherein the feed comprises a really simple syndication feed.

9. A computer implemented method of generating feeds for entities not associated with feed services, comprising:
receiving a registration from a user to receive a feed from an entity, irrespective of whether the entity provides the feed;
determining whether the entity provides the feed; and
accessing the feed from the entity and providing the feed to the user if the entity provides the feed, otherwise generating a new feed for the entity and providing the new feed to the user.

10. The computer implemented method of claim 9 wherein the feed comprises a web feed.

11. The computer implemented method of claim 9 further comprising receiving a configuration of the feed.

12. The computer implemented method of claim 9 further comprising providing the feed to the user through a messaging service.

13. The computer implemented method of claim 10 wherein the messaging service comprises at least one of an email service, a text messaging service, a video messaging service, an audio messaging service, or a voicemail service.

14. The computer implemented method of claim 9 further comprising providing the feed to the user through a feed protocol.

15. The computer implemented method of claim 14 wherein the feed protocol comprises a really simply syndication feed protocol.

16. The computer implemented method of claim 9 wherein the new feed provides a notification to the user when the entity is updated.

17. The computer implemented method of claim 16 wherein the new feed only provides the notification to the user if the entity is updated in accordance with an update criteria.

18. A system for providing an update to an entity via a feed, comprising:
a memory to store an identifier of an entity, the entity comprising of a content, an update condition, the update condition describing an update to the content of the entity, and a feed;
an interface operatively connected to the memory, the interface to communicate with a device of a user; and
a processor operatively connected to the memory and the interface, the processor for running instructions, wherein the processor receives the identifier of the entity from the device of the user via the interface, receives the update condition from the device of the user via the interface, generates the feed for the entity, adds the content of the entity to the feed when the content is updated in accordance with the update condition, and provides the feed to the device of the user via the interface.

19. The system of claim 18 wherein the feed comprises a web feed.

20. The system of claim 18 wherein the processor receives a configuration of the feed from the device of the user via the interface.

21. The system of claim 20 wherein the configuration comprises a time interval, the time interval indicating how often the content should be added to the feed.

22. The system of claim 18 wherein the processor provides the content to the user through a messaging service when the content is updated in accordance with the update condition.

23. The system of claim 22 wherein the messaging service comprises at least one of an email service, a text messaging service, a video messaging service, an audio messaging service, or a voicemail service.

24. The system of claim 18 wherein the entity comprises at least one of a web page, an intranet page, a feed, or a proprietary data source.

25. The system of claim 24 wherein the feed comprises an advertisement related to the entity.
